(19) United States
(12) Patent Application Publication
(10) Pub. No.: US 2024/0111824 A1
(43) Pub. Date: Apr. 4, 2024

(54) BOOLEAN SATISFIABILITY CIRCUIT ACCELERATOR

(71) Applicant: University of Southern California, Los Angeles, CA (US)

(72) Inventors: Tony Levi, Los Angeles, CA (US); Wei Wu, Los Angeles, CA (US); Sandeep Gupta, Los Angeles, CA (US); Buyun Chen, Los Angeles, CA (US); Zerui Liu, Los Angeles, CA (US); Deming Meng, Los Angeles, CA (US); Shiyu Su, Los Angeles, CA (US); Qiaochu Zhang, Los Angeles, CA (US); Shuo-Wei Chen, Los Angeles, CA (US)

(21) Appl. No.: 18/475,697

(22) Filed: Sep. 27, 2023

Related U.S. Application Data
(60) Provisional application No. 63/584,979, filed on Sep. 25, 2023.
(60) Provisional application No. 63/410,460, filed on Sep. 27, 2022.

(51) Int. Cl. G06F 17/11

(52) U.S. Cl. CPC G06F 17/11

(57) ABSTRACT

A circuit arrangement includes an array of switches that represent a Boolean satisfiability expression that has a plurality of clauses each defined by a combination of Boolean variables Xᵢ or ¬Xᵢ, a first plane, and a constraints network operatively arranged with the first plane. The constraints network enforces each of the clauses such that values of different ones of the variables continue to randomly or pseudo randomly flip until the values of the variables Xᵢ and ¬Xᵢ stop changing or a predetermined condition occurs.

### CROSS-REFERENCE TO RELATED APPLICATIONS

This application claims the benefit of U.S. Provisional Application Ser. No. 63/584,979, filed Sep. 25, 2023, and 63/410,460, filed Sep. 27, 2022, the disclosures of which are hereby incorporated in their entirety by reference herein.

### TECHNICAL FIELD

This disclosure relates to circuitry and arrangements thereof.

### BACKGROUND

The Boolean satisfiability (SAT) algorithm is used in hardware and software verification, autonomous systems, logistics, etc. As all known algorithms for SAT have exponential worst-case complexity, SAT run-time either adds weeks to product development or forces runtime limits that degrade results. Hence, acceleration of SAT will improve hardware and software correctness or time-to-market, enable significantly more capable autonomous systems, and so on. Acceleration of SAT will also accelerate an extremely large set of fundamental algorithms, as any nondeterministic polynomial (NP)-complete problem can be transformed to SAT in polynomial complexity.

### SUMMARY

A circuit arrangement includes an array of switches that represent a Boolean satisfiability expression that has a plurality of clauses each defined by a combination of Boolean variables Xᵢ or ¬Xᵢ, and a first plane including a plurality of pairs of wires. Each of the pairs is associated with one of the variables such that one of the wires of the pair is associated with the variable Xᵢ and the other of the wires of the pair is associated with the variable ¬Xᵢ. the circuit arrangement also includes a plurality of pairs of inverters. Each of the pairs of the inverters has one of the inverters with an input associated with the variable Xᵢ and an output associated with the variable ¬Xᵢ and the other one of the inverters with an input associated with the variable ¬Xᵢ and an output associated with the variable Xᵢ. The circuit arrangement further includes a constraints network operatively arranged with the first plane and that enforces each of the clauses such that values of different ones of the variables stored in the inverters continue to randomly or pseudo randomly flip until the values of the variables Xᵢ and ¬Xᵢ stop changing or a predetermined condition occurs.

A method for solving a Boolean satisfiability expression that has a plurality of clauses each defined by a combination of Boolean variables Xᵢ or ¬Xᵢ includes enforcing each of the clauses via a constraints network operatively arranged with a configurable switch array and a first plane that includes a plurality of pairs of wires, each of the pairs associated with one of the variables such that that one of the wires of the pair is associated with the variable Xᵢ and the other of the wires of the pair is associated with the variable ¬Xᵢ, such that values of different ones of the variables stored in pairs of inverters operatively arranged with the first plane continue to randomly or pseudo randomly flip until the values of the variables Xᵢ and ¬Xᵢ stop changing or a predetermined condition occurs.

### BRIEF DESCRIPTION OF THE DRAWINGS

FIG. 1 is a schematic diagram of an analog circuit structure for solving SAT problems.

FIGS. 2A-2C are Karnaugh maps associated with a SAT expression.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Polynomial (P) problems are easily solved in “polynomial time.” Thus, P problems are said to be easy or tractable. Solving NP-complete problems efficiently will significantly benefit both computer science and engineering. Currently, those problems however are difficult to solve on digital computers with the von Neumann architecture. Therefore, methods for alternative solutions to solve NP-complete problems are attractive for both science and industry. Among all the NP-complete problems, the SAT problem is quite famous. In the area of both computer science and logic, the SAT problem determines whether there is an answer that satisfies a given Boolean equation. In other words, the problem asks whether the variables of a given Boolean formula can be replaced by TRUE or FALSE in such a way that the formula still satisfies as a TRUE statement. If there exists an answer for the variables, the formula is called satisfiable. On the other hand, if there is no such assignment, the function expressed by the Boolean formula is FALSE for all possible variable assignments and the formula is unsatisfiable. For example, the Boolean formula “a AND b” is satisfiable because one can find the values a=TRUE and b=TRUE, which make (a AND b)=TRUE. “a AND NOT a,” however, is unsatisfiable since if a is TRUE, not a must be FALSE, which makes the formula unsatisfiable.

SAT is essential to many electronic design automation problems and has a wide application in the field of decision, scheduling, error-correction, and security domains. SAT is the first problem that was proven to be NP-complete. This means that the problems are in the complexity class of NP, including a large amount of decision, scheduling, and optimization problems, and are at most as difficult to solve as SAT. However, there is no known algorithm that can efficiently solve SAT problems, and it is generally believed that no such algorithm exists using the digital computer; yet this statement has not been proven theoretically. Many researchers dedicate their lives to this problem. Much research has been done from pure algorithms or the computer architecture side. Heuristic SAT algorithms can solve problem instances involving tens of thousands of variables and formulas consisting of millions of symbols, which is sufficient for many practical SAT problems from, for example, artificial intelligence, circuit design, and automatic theorem proving. An efficient analog circuit solving SAT problem was also recently introduced. This analog solution transforms the SAT problem to an optimization problem and then introduces a search type dynamics circuit to avoid local minima. With the inspiration of this optimization circuit, a more intuitive way of solving SAT problems is proposed.

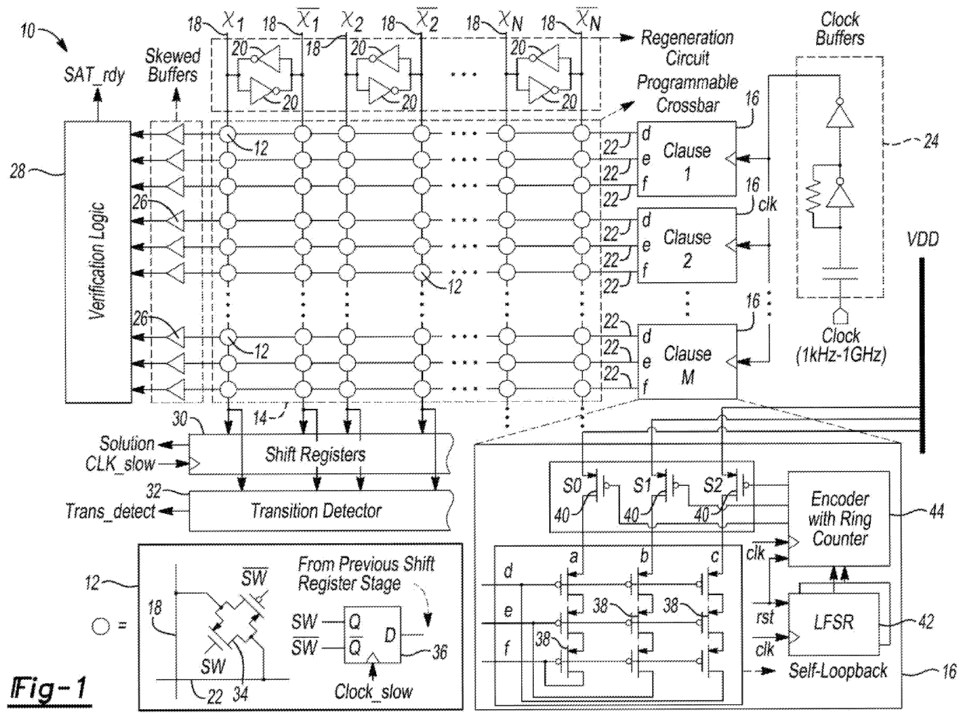

The proposed circuit, in some examples, has two parts: A memory cell on which to store the values of Xᵢ and ¬Xᵢ, and a constraints network to modify the memory cell. Within the constraints network, the transistors in some examples are P-channel metal-oxide semiconductor (PMOS) transistors. N-channel metal-oxide semiconductor (NMOS) transistors can also be used with some straight forward modifications. The purpose of this circuit is to find out whether Equation 1 below is true or not. Inspired from the intuitive understanding of the optimization circuit, the voltage outputs satisfying the constraint circuit will automatically lie in the feasibility set of the constraint condition of the optimization problem. Similarly for the SAT problem, if the circuit can be designed in a way that the output voltages will not exist unless they satisfy the formula, then the output voltage should automatically obey the Boolean formula. From this, an analog circuit is designed for the 3-SAT problem (as shown in FIG. 1).

(¬X₁∨¬X₂∨¬X₃)∧(¬X₁∨X₂∨¬X₃)∧ . . . ∧(¬X₁∨X₂∨¬X₃)=True Eq. 1

The crossbar circuit is a configurable switching matrix which can configure the circuit to the desired problem. Each constraint circuit will enforce each clause in the SAT problem. For example, if the statement is (¬X₁ ∨¬X₂ ∨¬X₃), then ¬X₁, ¬X₂, ¬X₃ will be connected to the constraint circuit. It can be easily observed that if all variables become 0 voltage, then the PMOS transistors in the constraint circuit will be turned on. Therefore, a power supply voltage (e.g., 5V) will drive the memory cell input from low to high. In this way, the variables cannot be 0 voltage at the same time. The voltage outputs that do not satisfy the SAT problem cannot exist in this circuit. Therefore, the SAT problem is satisfiable if the circuit can find an answer. Otherwise, the circuit will not stabilize if the SAT problem is unsatisfied.

Simulations on small size problems (i=2) were carried out for this approach (the circuit map 2-SAT problem). In this case, a 2-SAT problem with 3 clauses will only have one answer. The results from circuit simulation match the theoretical result of the SAT problem perfectly, which is consistent with previous analysis. This analysis, of course, is not a rigorous mathematical proof of the above circuit structure. The simulation only shows the feasibility of a small size problem (2-SAT problem). A more rigorous mathematical proof of the stability of this circuit in large scale is discussed below.

When the size of the problem grows larger (e.g., a 3-SAT problem with more clauses), more strategies should be implemented into the design of the circuit. If a clause such as (¬X₁ ∨¬X₂ ∨¬X₃) is not satisfied, which means all the variables (¬X₁, ¬X₂, ¬X₃) are 0 voltage, then the PMOS transistors in the constraint circuit will flip all the variables at the same time. This algorithm, however, may not be sufficient, which will be proved in the following.

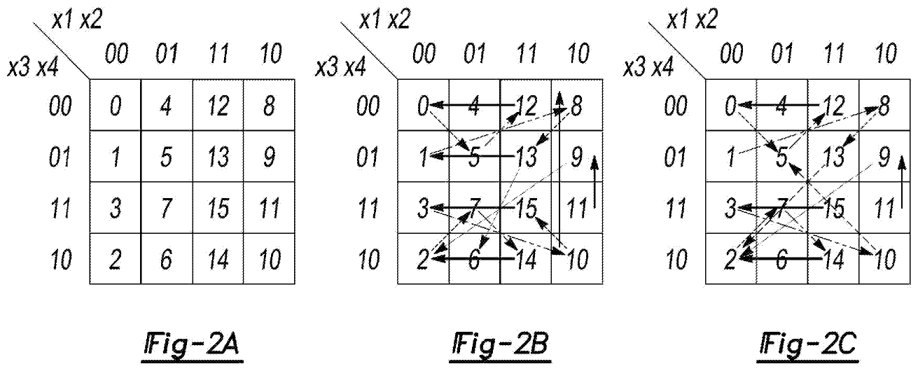

There are two main drawbacks when flipping all the literals in one clause simultaneously. First, this algorithm cannot fully retrieve all the states and infinite loops that exist during the flipping process. Equation 2 and FIGS. 2A through 2C are used as an example to illustrate the reason.

(¬X1∨¬X2)∧(¬X1∨X2∨¬X3)∧(¬X1∨X3∨¬X4)∧(X1∨¬X4)∧(X2∨X4) Eq. 2

Equation 2 contains 4 variables and 5 clauses. It is satisfiable and the solutions are 0100 and 0110 for X1˜X4. The Karnaugh map of X1˜X4 is shown in FIG. 2A. FIGS. 2B and 2C show the state changing. The circuit implements a simple 2-SAT problem of (X1 ∨X2)∧(X1 ∨¬X2) ∧(¬X1 ∨X2)=True. The circuit implements a simple 2-SAT problem of (X1 ∨X2)∧(X1 ∨¬X2)∧(¬X1 ∨¬X2)=True. The circuit implements a simple 2-SAT problem of (X1 ∨X2)∧(¬X1 ∨X2)∧(¬X1 ∨¬X2)=True. The circuit implements a simple 2-SAT problem of (X1 ∨¬X2)∧(¬X1 ∨X2)∧(¬X1 ∨¬X2)=True.

In FIG. 2B, the literals flip the states in only one clause due to the unsatisfaction. In FIG. 2C, the literals flip all the states in all the unsatisfied clauses. In both algorithms, some of the solutions cannot ever be achieved. In addition, there exists infinite loops such as 0→5→12→0 and 2→7→14→2 in both algorithms. These infinite loops could make the literals bounce back and forth, leading to infinite retrieving time. In addition, flipping all the literals increases the possibility of the circuit getting stuck. For these reasons, flipping all the literals is not a sufficient strategy.

An updated algorithm randomly flips one literal per clause. There are some advantages to this. First, only flipping one literal will not skip any solutions compared with flipping all literals, which will lead to some solutions that cannot ever be achieved. Second, flipping only one literal will get rid of the infinite loop problem due to the multiple choices. Furthermore, only flipping one literal will improve the stability of the circuit and resolve the stuck issues in the circuit.

Described in further detail below is an updated analog circuit structure designed to solve SAT problems, provided as 3-conjuctive normal form (CNF) expressions with less than Nᵥ variables and less than N_{c} clauses. The circuit may have the following components:

An input plane having Nᵥ pairs of vertical wires, i.e., a total of 2Nᵥ vertical wires. Each input variable is associated with one pair of wires, in which one wire in each pair is associated with the literal Xᵢ and the other is associated with ¬Xᵢ. Each pair of wires has two input inverters, one with input Xᵢ and output ¬Xᵢ, and the other with input ¬Xᵢ and output Xᵢ.

An output plane having three horizontal wires for each clause, i.e., a total of N_{c} horizontal wires. The three wires for each clause are connected to three bi-directional ports of a clause-logic block, i.e., there are N_{c} copies of the clause-logic block. Each clause-logic block contains three bi-directional ports. Each port contains 3 PMOS (or NMOS) transistors and a switch component, and it is also connected to a drain voltage (VDD in the case of PMOS transistors, ground in the case of NMOS transistors). Only one of the switches is turned on in the three ports at the same time, which can be realized by a random number generator.

A crosspoint array having a total of 6NᵥN_{c} programmable crosspoints. Each crosspoint is placed at the intersection of a vertical wire in the input plane and a horizontal wire in the output plane and includes an NMOS transistor whose source and drain are connected to the two wires. The gate of each crosspoint transistor is controlled by the value in a static random access memory (SRAM) cell. The 6NᵥN_{c} SRAM cells are organized as a standard 2Nᵥ*3N_{c} SRAM array (or as devices such as resistive random access memory (ReRAM) or memristors, etc.) with row and column decoders and read and write circuitry. The bi-directional circuit can be configured for any given 3-CNF by loading 0 or 1 into the cells in the SRAM array.

A completion monitor checking whether the values at the input lines (Xᵢ and ¬Xᵢ, ∀i) have ceased oscillations and stabilize at meaningful logic values.

The circuit operation is straightforward and entails two steps. First, for a new SAT problem, the given 3-CNF expression is converted into a corresponding map of 0s and 1s and loaded into the 2Nᵥ*3N_{c} SRAM array. Second, the values at the input plane lines corresponding to the literals Xᵢ and ¬Xᵢ, ∀i, are monitored by the completion monitor for the values to stabilize at meaningful logic values (i.e., either 0 and 1 for literals Xᵢ and ¬Xᵢ, or vice versa, ∀i).

Random voltage sources or random/pseudo random number generators are used in the clause-logic blocks to realize the function of only turning on one port at the same time. There are, however, other similar functions which can also accomplish this goal, such as a clock functions, single pole multiple throw switches/relays, etc.

A SPICE simulation of the proposed analog circuit for solving Equation 3 was conducted. Equation 3 is satisfiable and 001110 is one of the solutions.

(¬X1∨X5)∧(¬X2∨X3∨¬X6)∧(¬X1∨¬X3∨¬X5)∧(X2∨¬X6)∧(X1∨X4)∧(X3∨¬X5∨X6)∧(¬X1∨¬X2∨X4) Eq. 3

The initial state of X1˜X6 during the simulation was 100001. After less than 0.2 μs tuning time, the circuit finally stabilized at the solution 001110.

Table 1 shows the completeness test results of Equation 2. No matter the initial state changes, the proposed analog circuit could always find the solutions.

TABLE 1
SPICE simulation results of Equation
2 under different initial states.

| Initial State | X1234 | ¬ X1234 |
|---|---|---|
| 0000 | 0110 | 1001 |
| 0001 | 0110 | 1001 |
| 0010 | 0110 | 1001 |
| 0011 | 0110 | 1001 |
| 0100 | 0100 | 1011 |
| 0101 | 0100 | 1011 |
| 0110 | 0110 | 1001 |
| 0111 | 0110 | 1001 |
| 1000 | 0110 | 1001 |
| 1001 | 0110 | 1001 |
| 1010 | 0110 | 1001 |
| 1011 | 0110 | 1001 |
| 1100 | 0100 | 1011 |
| 1101 | 0100 | 1011 |
| 1110 | 0110 | 1001 |
| 1111 | 0110 | 1001 |

Bold: Solution to this Formula

Another feature of the circuit is what the performance of the unsatisfiable formula will show. A SPICE simulation of Equation 4 indicates that the literals always bounce back and forth because no solution can satisfy all the constraint circuitry simultaneously. The performance of the unsatisfiable formula is different from a satisfiable formula and thus is distinguishable therefrom.

(¬X1∨¬X2)∧(¬X1∨X2∨¬X3)∧(¬X1∨X3∨¬X4)∧(X1∨¬X4)∧(X2∨X4)∧(X1∨¬X2∨X4) Eq. 4

The above results show easy problems with few variables and a small clause variable ratio α. When α is larger than 4, the problem becomes hard and the difficulty to solve the problem dramatically increases. Equation 5 is a problem from benchmark SAT problems. It contains 20 variables and 91 clauses. 29 solutions exist from the 1048576 possibilities. A SPICE simulation of an analog circuit as proposed herein for solving Equation 5 showed that depending on the initial condition, it takes from 60 ns to 3.15 μs to stabilize. The average calculation time is around 520 ns. Considering that the flipping time is 26 ns based on the PMOS transistors and inverter components, the circuit only takes tens of cycles to find the solution. Compared with a less than 0.003% satisfaction rate for this equation, the calculation time is extremely fast.

(¬X10∨¬X16∨X5)∧(X16∨¬X6∨X5)∧(¬X17∨¬X14∨¬X18)∧(¬X10∨¬X15∨X19)∧(¬X1∨¬X9∨¬X18)∧(X3∨X7∨¬X6)∧(¬X13∨X1∨X6)∧(¬X2∨¬X16∨¬X20)∧(X7∨X8∨X18)∧(¬X7∨X10∨¬X20)∧(X2∨¬X14∨¬X17)∧(X2∨X1∨X19)∧(X7∨¬X20∨¬X1)∧(¬X11∨X1∨¬X17)∧(X3∨¬X12∨X19)∧(¬X3∨¬X13∨X6)∧(¬X13∨X3∨¬X12)∧(X5∨¬X7∨¬X12)∧(X20∨X8∨¬X16)∧(¬X13∨¬X6∨X19)∧(¬X5∨X1∨X14)∧(X9∨¬X5∨X18)∧(¬X12∨¬X17∨¬X1)∧(¬X20∨¬X16∨X19)∧(X12∨X10∨¬X11)∧(X6∨¬X7∨¬X2)∧(X13∨¬X10∨X17)∧(¬X20∨X8∨¬X16)∧(¬X10∨¬X1∨¬X8)∧(¬X7∨¬X3∨X19)∧(X19∨¬X1∨¬X6)∧(X19∨¬X2∨X13)∧(¬X2∨X20∨¬X9)∧(¬X8∨¬X20∨X16)∧(¬X13∨¬X1∨X11)∧(X15∨¬X12∨¬X6)∧(¬X17∨¬X19∨X9)∧(X19∨¬X18∨X16)∧(X7∨¬X8∨¬X19)∧(¬X3∨¬X7∨¬X1)∧(X7∨¬X17∨¬X16)∧(¬X2∨¬X14∨X1)∧(¬X18∨¬X10∨¬X8)∧(¬X16∨X5∨X8)∧(X4∨X8∨X10)∧(¬X20∨¬X11∨¬X19)∧(X8∨¬X16∨¬X6)∧(X18∨X12∨X8)∧(¬X5∨¬X20∨¬X10)∧(X16∨X17∨X3)∧(X7∨¬X1∨¬X17)∧(X17∨¬X4∨X7)∧(X20∨¬X9∨¬X13)∧(X13∨X18∨X16)∧(¬X16∨¬X6∨X5)∧(X5∨X17∨X7)∧(¬X12∨¬X17∨¬X6)∧(¬X20∨X19∨¬X5)∧(X9∨¬X19∨X16)∧(¬X13∨¬X16∨X11)∧(¬X4∨¬X19∨¬X18)∧(¬X13∨X10∨¬X15)∧(X16∨¬X7∨¬X14)∧(¬X19∨¬X7∨¬X18)∧(¬X20∨X5∨X13)∧(X12∨¬X6∨X4)∧(X7∨X9∨¬X13)∧(X16∨X3∨X7)∧(X9∨¬X1∨X12)∧(¬X3∨X14∨X7)∧(X1∨X15∨X14)∧(¬X8∨¬X11∨X18)∧(X19∨¬X9∨X7)∧(¬X10∨X6∨X2)∧(X14∨X18∨¬X11)∧(¬X9∨¬X16∨X14)∧(X1∨X11∨¬X20)∧(X11∨X12∨¬X4)∧(X13∨¬X11∨¬X14)∧(X17∨¬X12∨X9)∧(X14∨X9∨X1)∧(X8∨X19∨X4)∧(X6∨¬X13∨¬X20)∧(¬X2∨¬X13∨X11)∧(X14∨¬X13∨X17)∧(X9∨¬X11∨X18)∧(¬X13∨¬X6∨X5)∧(X5∨X19∨¬X18)∧(¬X4∨X10∨X11)∧(¬X18∨¬X19∨¬X20)∧(X3∨¬X9∨X8) Eq. 5

Besides the approaches mentioned previously, there is another variation. Starting with “weakened” inverters, the clauses are always satisfied in the beginning when those inverters are not working. Then the inverters work “stronger” and “stronger,” and let variables and NOT of those variables “fight” at the same time. Finally, the circuit can stabilize at the final solution state. It is the annealing approach, and it is another algorithm to find out the solutions of the formula.

Referring to FIG. 1, a circuit arrangement 10 includes a plurality of switch arrangements 12 defining an array 14, a plurality of clause-logic blocks 16, a plurality of pairs of wires 18 defining a first plane, a plurality of pairs of inverters 20, a plurality of trios of clause wires 22 defining a second plane, clock buffers 24, a plurality of skewed buffers 26, verification logic 28, a bank of shift registers 30, and a transition detector 32.

Each of the switch arrangements 12 includes a switch 34 and a memory cell 36. Each of the switches 34 is connected with one of the wires 18 and one of the clause wires 22.

The array 14 as mentioned above can be configured to represent a Boolean satisfiability expression that has a plurality of clauses each defined by a combination of Boolean variables Xi or ¬Xi. The clauses are embodied by the clause-logic blocks 16.

Each of the pairs of wires 18 is associated with one of the variables. As a result, for each of the pairs of wires 18 one of the wires 18 is associated with the variable Xi and the other of the wires 18 is associated with the variable ¬Xi. Moreover, for each of the pairs of the inverters 20, one of the inverters has an input associated with the variable Xi and the other of the inverters 20 has an input associated with the variable ¬Xi.

Each of the clause wires 22 is on one end configured to be connected with at least some of the wires 18 via at least some of the switch arrangements 12, and on another end connected with one of the clause-logic blocks 16.

Each of the clause-logic blocks includes a plurality of field effect transistors 38 (e.g., self-loopback P-type or N-type metal-oxide-semiconductor field-effect transistors), a plurality of switches 40, a linear feedback shift register 42, and a ring-counter-based encoder 44. The switches 38 are arranged in series connected columns, each associated with one of the switches 40. A gate of each of the switches 38 is connected with one of the clause wires 22 and thus may be connected with at least one of the wires 18 via at least one of the switch arrangements 12.

Each of the switches 40 are connected between one of the columns and a drain voltage, VDD in this example. The linear feedback shift register 42 and ring-counter-based encoder 44 are arranged to generate random or pseudo random numbers. These numbers (signals) are used to turn on one of the switches 40 (S0, S1, or S2) with equal probability. As such, each of the clause-logic blocks 16 will avoid being trapped in an unwanted state and continue to search for the correct solution.

The reset signal (rst) is exerted on the linear feedback shift register 42 and ring-counter-based encoder 44 before powering the circuit 10 to set initial conditions to zero.

The clause-logic blocks 16 and clause wires 22 thus define a constraints network operatively arranged with the first plane that is configured to enforce the clauses via random activation of the switches 40. As described above, enforcement of each of the clauses continues to cause values of different ones of the variables stored in the inverters 20 to randomly flip until the values of the variables Xi and ¬Xi stop changing or a predetermined condition occurs, such as expiration of a predefined period of time, etc.

The clock buffers 24 are configured to buffer a clock signal before input to the clause-logic blocks 16.

The skewed buffers 26 are arranged with the second plane and are configured to detect whether continuous signals on the constraints network exceed a predefined threshold. The predefined threshold is greater than half a value between the drain voltage and ground. For example, if the drain voltage is VDD, each of the skewed buffers 26 may output a 1 if a voltage on a corresponding clause wire 22 exceeds 0.7VDD, and may output a 0 otherwise.

The verification logic 28 is configured to check whether output of the skewed buffers 26 satisfy the Boolean satisfiability expression. If, for example, the output of all the skewed buffers 26 is 1, then the verification logic outputs a 1 (via the SAT_rdy signal) indicating the solution is correct. Otherwise, the verification logic outputs a 0 indicating the solution is not correct.

The bank of shift registers 30 is arranged with the first plane to read out values (via the Solution signal) of the variables Xi and ¬Xi after the values settle. The bank of shift registers receives a clock signal (CLK_slow) at a speed that permits the read out to take place without issue.

The transition detector 32 is arranged with the first plane to detect and generate corresponding out (via the Trans_dectect signal) indicating whether values of the variables Xi and ¬Xi have stopped changing or whether the predetermined condition has occurred.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A circuit arrangement comprising:
an array of switches configured to represent a Boolean satisfiability expression that has a plurality of clauses each defined by a combination of Boolean variables Xᵢ or ¬Xᵢ;
a first plane including a plurality of pairs of wires, each of the pairs being associated with one of the variables such that one of the wires of the pair is associated with the variable Xᵢ and the other of the wires of the pair is associated with the variable ¬Xᵢ;
a plurality of pairs of inverters, each of the pairs of the inverters having one of the inverters with an input associated with the variable Xᵢ and an output associated with the variable ¬Xᵢ and the other one of the inverters with an input associated with the variable ¬Xᵢ and an output associated with the variable Xᵢ; and
a constraints network operatively arranged with the first plane and configured to enforce each of the clauses such that values of different ones of the variables stored in the inverters continue to randomly or pseudo randomly flip until the values of the variables Xᵢ and ¬Xᵢ stop changing or a predetermined condition occurs.

2. The circuit arrangement of claim 1, wherein the constraints network includes a second plane including a trio of clause wires for each of the clauses and wherein for each of the clause wires, one end is configured to be connected with at least some of the wires via at least some of the switches and the other end is configured to be connected with a drain voltage.

3. The circuit arrangement of claim 2, wherein the constraints network includes a plurality of clause-logic blocks each embodying one of the clauses and connected with one of the trios.

4. The circuit arrangement of claim 3, wherein each of the clause-logic blocks includes a plurality of series connected field-effect transistors.

5. The circuit arrangement of claim 4, wherein the field-effect transistors are P-type or N-type metal-oxide-semiconductor field-effect transistors.

6. The circuit arrangement of claim 5, wherein for each of the P-type or N-type metal-oxide-semiconductor field-effect transistors, a gate of the P-type or N-type metal-oxide-semiconductor field-effect transistor is configured to be connected with at least one of the wires via at least one of the switches according to the clause embodied by the clause-logic block.

7. The circuit arrangement of claim 4, wherein each of the clause logic blocks includes at least one switch configured to connect at least some of the field-effect transistors with the drain voltage.

8. The circuit arrangement of claim 3, wherein each of the switches has a terminal connected with one of the wires of the first plane and another terminal connected with one of the clause wires of the second plane.

9. The circuit arrangement of claim 8, wherein the switches are further configured such that, for each of the clause-logic blocks, at least one of the switches is activated to connect the cause-logic block and at least one of the wires according to the clause embodied by the clause-logic block.

10. The circuit arrangement of claim 1 further comprising a monitor configured to check whether the values of the variables Xᵢ and ¬Xᵢ have stopped changing or the predetermined condition has occurred.

11. The circuit arrangement of claim 2 further comprising a bank of skewed buffers configured to detect whether a voltage of each of a plurality of continuous signals on the constraints network exceeds a predefined threshold that is greater than half a value between the drain voltage and ground.

12. The circuit arrangement of claim 11 further comprising logic configured to verify whether output of the skewed buffers satisfies the Boolean satisfiability expression.

13. The circuit arrangement of claim 1 further comprising a bank of shift registers configured to read out the values of the variables Xᵢ and ¬Xᵢ after the values settle.

14. The circuit arrangement of claim 3, wherein each of the clause-logic blocks includes a linear feedback shift register and a ring-counter-based encoder configured to generate random or pseudo random numbers for the enforcement.

15. A method for solving a Boolean satisfiability expression that has a plurality of clauses each defined by a combination of Boolean variables Xᵢ or ¬Xᵢ, comprising:
enforcing each of the clauses via a constraints network operatively arranged with a configurable switch array and a first plane that includes a plurality of pairs of wires, each of the pairs associated with one of the variables such that that one of the wires of the pair is associated with the variable Xᵢ and the other of the wires of the pair is associated with the variable ¬Xᵢ, such that values of different ones of the variables stored in pairs of inverters operatively arranged with the first plane continue to randomly or pseudo randomly flip until the values of the variables Xᵢ and ¬Xᵢ stop changing or a predetermined condition occurs.

16. The method of claim 15, wherein the enforcing includes generating random or pseudo random numbers.

17. The method of claim 16, wherein the generating is performed via a linear feedback shift register and a ring-counter-based encoder.

18. The method of claim 15 further comprising generating output responsive to detecting whether each of a plurality of continuous signals on the constraints network exceeds a predefined threshold that is greater than half a drain voltage connected with the constraints network.

19. The method of claim 18 further comprising verifying whether the output satisfies the Boolean satisfiability expression.

20. The method of claim 15 further comprising reading out the values of the variables Xᵢ and ¬Xᵢ after the values settle.
